(19) United States
(12) Patent Application Publication
(10) Pub. No.: US 2007/0076688 A1
(43) Pub. Date: Apr. 5, 2007

(54) Communications network and method for transmitting data in a communications network

(75) Inventor: Michael Johannes Fuss, Allmersbach (DE)

Correspondence Address: KIRSCHSTEIN, OTTINGER, ISRAEL;& SCHIFFMILLER, P.C., 489 FIFTH AVENUE, NEW YORK, NY, 10017, US

(73) Assignee: MARCONI COMMUNICATIONS GMBH, Backnang (DE)

(21) Appl. No.: 10/544,316

(22) PCT Filed: Jan. 26, 2004
(86) PCT No.: PCT/IB04/00675

§ 371 Date: May 12, 2006

(30) Foreign Application Priority Data
Feb. 3, 2003 (DE) 103 43 47.0

(51) Int. Cl. H04L 12/66

(52) U.S. Cl. 370/352; 370/310

(57) ABSTRACT

The invention relates to a communications network comprising a large number of nodes (1, 2, . . . , 7), at least two (1, 7) of which are connected via at least two different routes (1-2-3, 3-4, 4-7; 1-2-3, 3-5, 5-6, 6-7). At least one of said routes comprises a radio link (3-4), which runs from a transmitter to a receiver. The transmitter and the receiver support a large number of transmission modes with varying robustness and data throughputs and comprise elements (17) for defining the transmission mode used depending on the detected transmission quality of the radio link (3-4, . . . ). The communications network is also equipped with elements for distributing (15, 18) the data traffic that is to be transmitted from one of the two nodes (1) to the other (7) between the two routes (1-2-3, 3-4, 4-7; 1-2-3, 3-5, 5-6, 6-7), according to their data throughput.

The present invention concerns a communications network with a large number of nodes, at least two of which are connected via at least two different routes, at least one of which includes a radio link, as well as a method for transmission of a data stream between these two nodes.

The data rate attainable on such a radio link depends on environmental effects, especially the weather prevailing along the radio link. In the past, line-bound transmission links independent of weather effects were therefore primarily used between the nodes of communications networks. The transmission rate of such a line-bound transmission link under normal operating conditions is invariable; during interferences, for example during interference on a connected node or a physical interruption of the link, no transmission is possible.

If radio links are used for transmission between two nodes individually in such a communications network, a transmission rate with high failure security must also be guaranteed for these radio links. Consequently, only a very robust transmission mode can be used on the radio link in order to ensure that the radio link is available with the required data throughput with sufficient reliability. The higher the requirements on failure security, the smaller the percentage of operating time in which such a robust mode is actually required. During most of the operating time, a less robust mode and a corresponding higher data rate could be used. This means that the attainable data transmission rates on such a radio link are generally higher than the actually used rate.

In U.S. Pat. No. 6,330,278 B1 a modem is proposed as starting point and end point for a radio link, which is capable of evaluating the quality of transmission on the radio link, and dynamically adapting the mode of transmission used on the radio link to the recorded transmission quality. Such a modem is suitable for transmission of non-time-critical data, during whose transmission delays can be tolerated in case of poor transmission conditions on the radio link. However, if such a modem is used to transmit time-critical data, such as telephone or video data, and the data rates on the radio link must be reduced because of deterioration in transmission conditions, this leads to transmission disturbances and interruption of the connection.

The task of the present invention is to devise a communications network with at least one radio link between two nodes connected via different routes in which the transmission rate of the radio link is variable, and which is suitable for transmission of data with an assured data rate.

The task is solved by a communications network with the features of Claim 1. The means to distribute the data traffic in case of a reduction of transmission capacity of the radio link because of a deterioration in conditions permit shifting of part of the data traffic transmitted previously on the radio link to the second transmission route, so that the data rate on the radio link is adapted to the instantaneous transmission capacity, and jamming of the radio link by data waiting for transmission is avoided. Critical delays of data traffic also transmitted on the radio link are avoided, so that time-critical data contained in it are also transmitted in timely fashion.

No critical delays occur in the data relocated to the second transmission route if sufficient transmission capacity is free on this second route.

Preferably the data traffic transmitted via the radio link consists of a partial stream with assured data rate and a partial stream with a non-assured data rate, for example in the form of file transmissions, Internet accesses, etc. The relocated part of the data stream is then preferably formed from the partial stream with the non-assured rate. This means that if data with assured rate is contained in the relocated part, its percentage in the relocated part in each case is less than that on the transmitted part of the data stream on the radio link.

Preferably only data from the partial stream with assured rate is relocated to the second route if the transmission rate of the mode established for the radio link is lower than the rate of the partial stream with an established rate which therefore can no longer be fully transmitted on the radio link.

In the partial data stream with the unfixed rate it is also useful to distinguish between time-critical data, such as compressed telephone or video data on the one hand, and non-time-critical data on the other, and to form the relocated part of the data stream preferably from the percentage of non-time-critical data.

In this manner transmission errors are avoided which might result if it turned out that a maximum admissible delay cannot be guaranteed for the data relocated to the second route.

If the transmission quality of the second route is not sufficient in order to handle the data traffic, the data stream relocated on the second route can be discarded if no transmission capacity is available on the second route. This can occur in simple fashion by means of a buffer memory in which the data stream relocated on the second route is temporarily stored before transmission on the second route and its contents cyclically overwritten, regardless of whether it was transmitted or not.

In order to be able to adapt the employed mode of transmission continuously to the transmission conditions of the radio link, the transmission quality can be measured at the receiver, for example by means of a bit error rate and reported to the transmitter.

If the radio link is bidirectional and it can be assumed that the transmission quality is the same in both transmission directions, the transmission quality of the radio link can also be measured simply at the location of the transmitter on a signal transmitted in the opposite direction.

The radio link can be a point-to-point or also a point-to-multipoint connection. In a point-to-multipoint operation between an exchange and several outstations, the transmitter of the exchange must transmit access control information to the outstations in order to notify them of the times at which they may transmit to the exchange. If the transmitter of such an exchange, however, is used in point-to-point operation, transmission of access control information is redundant, so that the transmission bandwidth not required for this can be utilized in order to transmit useful data.

Preferably on the radio link between the transmitter and receiver, ATM cells without a higher level frame structure are transmitted. This facilitates exchange between different modes of transmission with different durations required for transmission of the cell.

Additional features and advantages of the invention are apparent from the following description of practical examples with reference to the accompanying drawings. In the drawings:

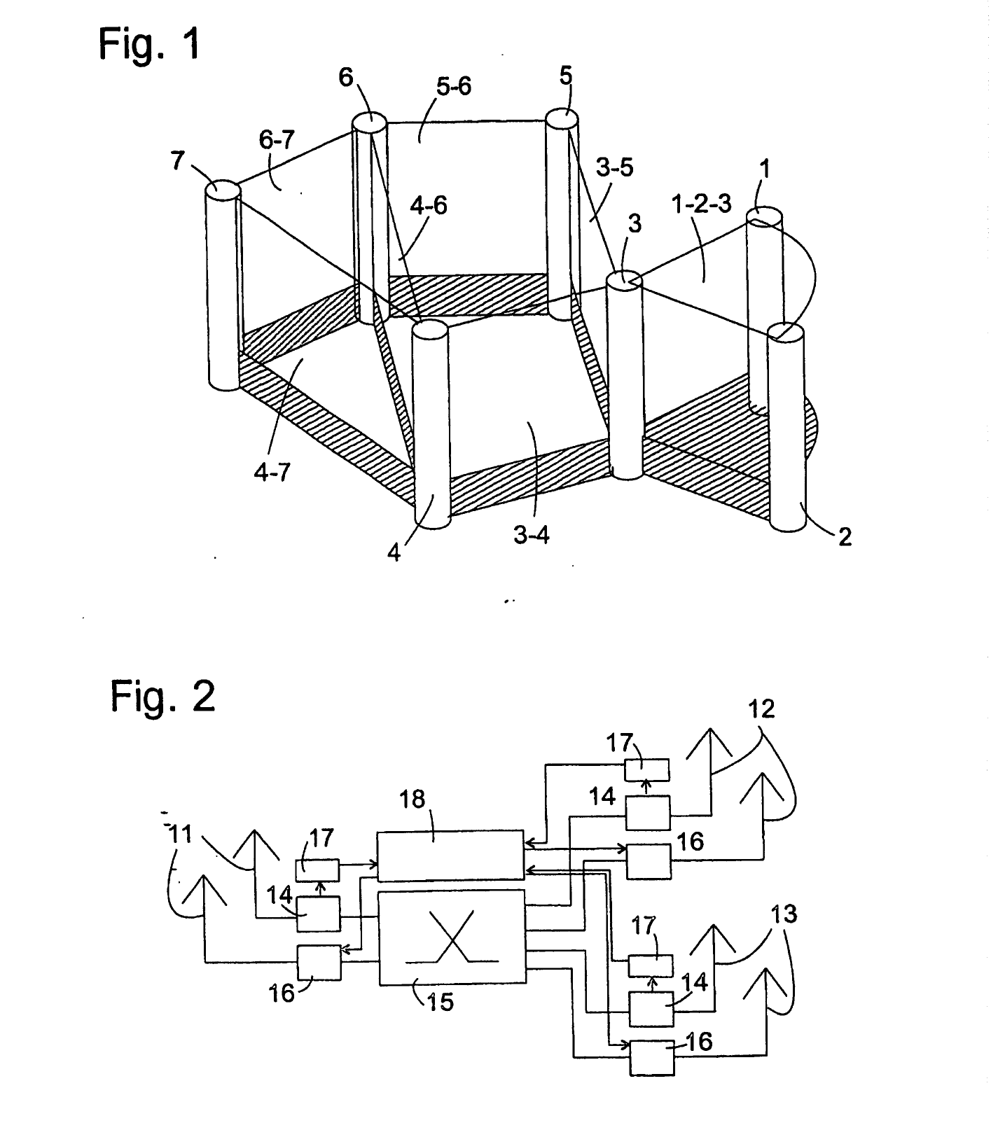

FIG. 1 shows a schematic view of a radio communication system according to the invention, showing the variable transmission rates of the radio links between nodes;

FIG. 2 shows a block diagram of a node of the radio communication system;

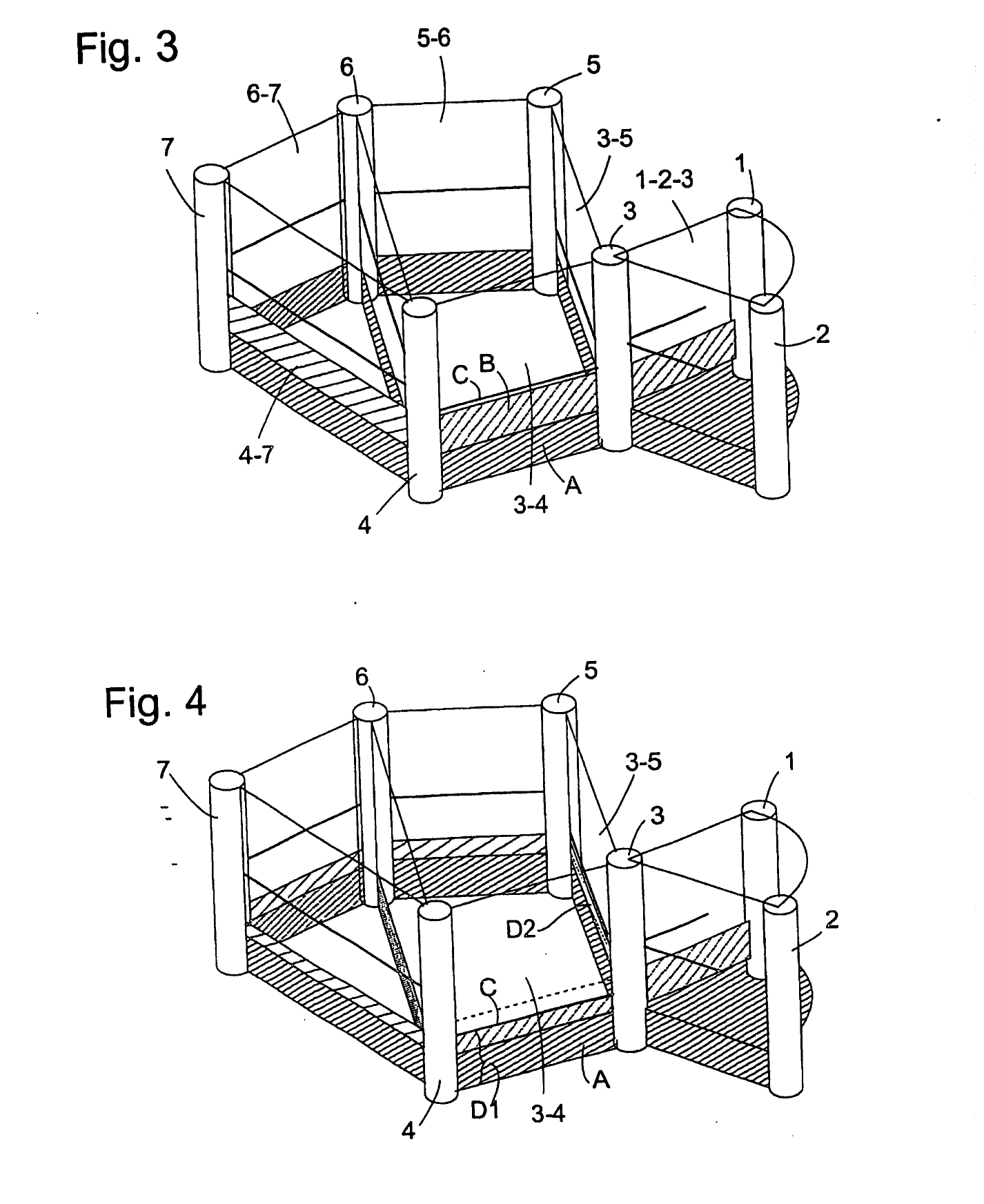

FIG. 3 shows an example of transmission modes and work loads of the radio links at one time;

FIG. 4 shows the work loads of the radio links during transmission conditions of a radio link that have deteriorated relative to the situation in FIG. 2; and

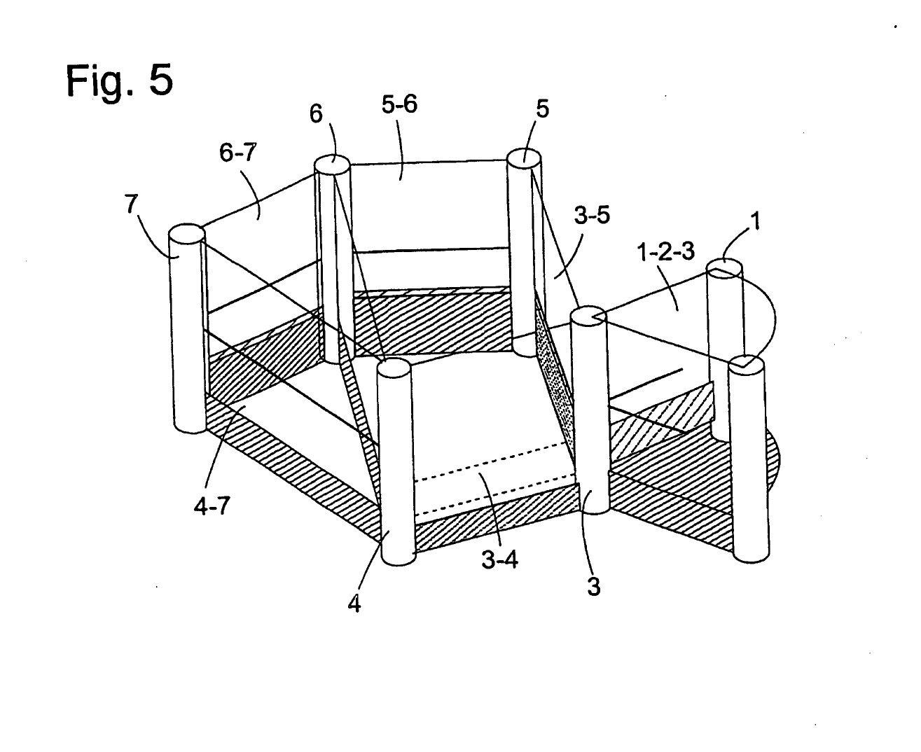

FIG. 5 shows the work loads of the radio links with more deteriorated transmission conditions.

FIG. 1 is a highly schematized view of a radio communications network according to the invention. The nodes of the network are symbolized by cylindrical columns 1 to 7. Point-to-point radio links i-j run between nodes 3 to 7 in which i, j are the reference numbers of the nodes participating in the radio link. Each directional radio link i-j includes two closely bundled antennas aligned toward each other at the nodes i, j whose opening angle is set so that it only reaches the antenna of the corresponding partner node. The point-to-point radio links are shown in the figure by bands between nodes transparent in the upper region and shaded in the lower region.

Between nodes 1, 2 and 3 a point-to-multipoint radio link is constructed by a sector antenna at node 3, which can reach both nodes 1, 2 simultaneously, as well as bundled antennas at nodes 1 and 2 aligned to node 3. The point-to-multipoint radio link is symbolized by a cylindrical segments configuration 1-2-3 whose apex forms node 3 and which is also transparent in the upper region and shaded in the lower region.

FIG. 2 shows the structure of such a node using the example of node 3. The node has three antennas 11 to 12, including two bundled antennas 11, 12 which are part of radio links 3-4 and 3-5, and a sector antenna 13 which belongs to radio link 1-2-3. At each antenna a receiver 14, which demodulates ATM cells received via the antenna decodes them and sends them to switching matrix 15, modulates them and sends them to the antenna. A transmission circuit 17 is allocated to each receiver 14 which extracts conducting route information and transmission error rates from the received cells and sends them to the control circuit 18. By means of the conducting route information the latter establishes a route for each cell and controls the switching matrix 15 in order to send each cell on the route established for it.

The transmitter 16 and receiver 14 of nodes 1 to 7 support a large number of transmission modes that differ in modulation and/or coding and have different data rates and robustness.

When an identical frequency is used for transmission in both directions on a radio link between two nodes, the transmission quality for both directions is the same, and it is sufficient that one of the two transmission circuits 17 participating in the radio link of the nodes records the transmission error rate and establishes an appropriate transmission mode for the radio link based on it. However, it is also possible that both transmission circuits establish a transmission mode independently of each other, in which the more robust one is then preferably used for transmission in both directions.

The establishment of a transmission mode by means of the error rate occurs by the transmission circuit comparing the measured transmission error rate with a stipulated highest limit and a lower limit.

If the error rate surpasses the highest limit or falls short of the lower limit, the transmission circuit 17 chooses the next more robust or less robust transmission node from among the supported modes.

An alternative possibility for establishing the transmission mode is to always change to a more robust transmission mode when the initial highest limit of the error rate is surpassed, but only choose a less robust mode if a requirement exists for more transmission capacity than the presently used mode has, and the change to the less robust mode does not lead to an error rate above the highest limit.

If different frequencies are used on the radio link for transmission in different directions, the transmission qualities can be different for the directions. The establishment of a transmission mode then occurs as described above, but independently of each other on the two transmission circuits 17, and each transmission circuit sends a command to use the mode established by it to the node that forms the opposite end of the radio link.

The height of the bands i-j and the configuration 1-2-3 in FIG. 1 is a gauge of the highest data rate attainable with the most rapid supported transmission mode on the corresponding transmission route. In the example considered here, it is assumed identical for all transmission routes, but this naturally is not essential. Depending on the degree of technical development, the number of supported transmission modes and the maximum data rates can differ. The height of the shaded area is a gauge of the nominal data rate of the radio link, i.e., a data rate that can be achieved with a probability bordering 100% security -ε. In the interest of simplicity, this is also assumed to be equal for all radio links, but could also be different. The nodes communicate on the radio links by means of ATM cells whose number per unit time varies depending on the employed transmission mode.

FIG. 3 explains the communication system from FIG. 1 in a practical use situation. Lines drawn bold between nodes i, j=1, 2, 7 each show the maximum data rate attainable on radio link i-j under the actual weather conditions. In the point-to-point radio link this data rate is naturally the same on both ends of the radio link; in the point-to-multipoint radio link 1-2-3, the nominal data rate on node 3 consists of the amounts of traffic between 2 and 3 and 1 and 3, which is limited by the nominal data rate and are variable individually according to the requirements of nodes 1, 2. In order to symbolize this state of affairs, the bold lines between nodes 3 and 1 and 3 and 2 are not continuous.

It is assumed that the nominal data rate of all radio links is loaded by data traffic A with a fixed, assured rate. The transmission conditions on all radio links, however, are so good that during use of an adjusted transmission mode, much more than the nominal data rate can be transmitted. By continuous monitoring of the transmission quality of the radio links on the nodes and dynamic adjustment of the transmission modes to the quality, data rates on the radio links i-j proportional to the height of the solid lines drawn in the corresponding radio links are available. The additional capacity going beyond the nominal data rate, can in principle, be used to transmit any type of data traffic, but preferably it is used for data traffic for which no fixed data rate need be assured, for example compressed audio or video data, file transfers, communications with the Internet, etc.

In the interest of simplicity it is assumed in FIG. 3 that traffic without an assured data rate B is only generated on node 1, conveyed via nodes 3 and 4 and terminated on node 7; in practice, such traffic is generally generated and terminated on all nodes at different rates. The data traffic without assured data rate from node 1 to node 7 is symbolized in FIG. 3 by darkly shaded bands B on radio links 1-2-3, 3-4 and 4-7.

Of the different radio links participating in transmission, in this example link 3-4 has the poorest transmission conditions, but its capacity is still sufficient to handle both the data traffic A with assured rate and the traffic B with the non-assured rate, as shown by the limited distance between the two shaded bands and the bold line of this radio link. Unutilized capacity corresponding to this distance is filled up with full cells.

FIG. 4 shows a situation in which the transmission conditions on radio link 3-4 have deteriorated, so that a transmission mode must be used whose transmission rate is lower than that of the situation of the total traffic A+B transmitted in FIG. 3. In this situation, the traffic A+B actually transmitted on radio link 3-4 is divided into a first partial stream D1 whose rate corresponds to the transmission rate of the currently used mode on radio link 3-4, and is also transmitted on link 3-4 and a second partial stream D2 for which a new route from node 3 to node 7 must be sought.

Since searching for a new transmission route requires time and it is not necessarily guaranteed that such a route exists, if possible only traffic without an assured rate is assigned to the partial stream D2, in which transmission delays are tolerable. Disturbances in traffic with an assured rate are ruled out by the fact that the data rate instantaneously attainable on a radio link does not drop below the nominal data rate.

If in data traffic with non-assured rate a distinction between time-critical traffic, for example compressed audio/video data, and non-time-critical traffic, such as data transfer and Internet communications is possible, primarily the non-time-critical traffic is assigned to the second partial stream D2. Time-critical traffic is only relocated to the second partial stream D2 if the relocation of the non-time-critical traffic is not sufficient to reduce the data rate on connection 3-4 to the level transmittable in the present transmission mode.

In the example considered here, a substitute transmission route for the second partial stream D2 was found via nodes 5 and 6. The capacity of the radio link 3-5 is just sufficient to take over the relocated traffic D2 in addition to the traffic with assured rate transmitted on it ordinarily.

FIG. 5 shows the situation with deteriorated transmission conditions on radio link 3-4. In the rare exceptional situation considered here, the data rate corresponding to the used transmission mode is lower than the nominal data rate of the radio link, so that even the traffic with the assured rate can no longer be fully transmitted. In this situation it is essential and, considering the transmission conditions on the other radio links, also possible to divert traffic with the assured rate which no longer has room on radio link 3-4 via nodes 5, 6. Because of this, the traffic with assured rate is increased beyond the nominal data rate of radio links 3-5, 5-6 and 6-7, which is easily possible since these transmission modes each use a higher rate than the nominal data rate. As can be seen, an effective failure security for radio link 3-4 is still achieved above its value 100%-ε. corresponding to its normal data rate, since in this case, with the probability ε that the nominal data rate cannot be maintained on radio link 3-4, a relocation of traffic is always possible, unless only the nominal data rate is transmittable on available alternative routes.

The less capable transmission mode used on radio link 3-4 is now no longer sufficient to handle all the data traffic that must be transmitted on this route, and which consists of the traffic already transmitted on this route under the conditions of FIG. 3 and the traffic relocated from route 3-4. Radio link 3-5 in this situation is treated in exactly the same way as route 3-4 previously: for traffic that route 3-5 cannot manage, preferably for the traffic with non-assured data rate, a bypass route is sought and only a small amount of traffic with the non-assured rate, depicted as narrower, thickly shaded stripes, is transmitted via route 3-5 and the following routes 5-6, 6-7.

In the example treated here no bypass route exists for the traffic that can no longer be accommodated on route 3-5. It is therefore buffered in a transmitter buffer or transmitter 16 of node 3 if transmission capacity becomes free on route 3-5 for a short time in order to then transmit it, even if delayed. The buffer is then cyclically overwritten with the data being transmitted, so that data that cannot be sent in timely fashion on route 3-5 are lost.

The principle of traffic rerouting described above for a point-to-point radio link with insufficient transmission capacity is also applicable for point-to-multipoint radio links like 1-2-3. The establishment of the transmission mode between modes 1 and 3 can occur independently of the transmission mode between 3 and 2. This is useful in radio links of longer range in which distinct differences in transmission conditions are possible between nodes 1 and 2, on the one hand, and 2 and 3, on the other. It is simpler and useful with smaller range of the radio link to establish the same transmission mode for all nodes.

A point-to-multipoint radio link is useful for the connection of nodes like 1, 2 to the network, which (still) have unduly low traffic occurrence in order to justify a directional radio link. If the traffic occurrence of these nodes increases, the sector antenna 13 at node 3 can be replaced by a bundled antenna aligned to node 1 of the same type as antennas 11, 12 and an additional group consisting of transmitter 16, receiver 14, monitoring circuit 17 and antennas for connection to nodes 2 can be added. The initial investment in the network can thus be kept low and its performance can continuously be increased to adapt to corresponding requirements.

Cells that node 3 transmits on the point-to-multipoint radio link must be linked to information that establishes the target nodes 1 or 2 of each cell. This can occur by emitting each cell with a code that identifies the target nodes, or by establishing time windows in which only cells for one of the nodes are emitted, and information about this is transmitted to nodes 1, 2. During switching to a point-to-point radio link, this coding or information could be emitted further. This would make switching from point-to-multipoint to point-to-point transmission particularly simple. However, it is more advantageous to no longer emit this code or information after switching and to use transmission capacity that has become free for useful data transmission.

1-13. (canceled)

14. A communications network, comprising:
a) a plurality of nodes, at least two of the nodes being connected via at least two different routes, at least one of the nodes including a radio link running from a transmitter to a receiver, the transmitter and the receiver supporting a plurality of transmission modes with different robustness and data rates;
b) means for establishing an employed transmission mode as a function of a recorded transmission quality of the radio link; and
c) means for distributing data traffic from one of the at least two nodes to the other of the at least two nodes on the at least two routes corresponding to their data rate.

15. The communications network according to claim 14, in that the radio link is a point-to-point connection.

16. The communications network according to claim 14, in that the radio link is a point-to-multipoint connection.

17. The communications network according to claim 14, in that the radio link is bidirectional.

18. The communications network according to claim 14, in that the transmitter is used in point-to-point or point-to-multipoint operation, in which bandwidth of the radio link is used in point-to-multipoint operation for transmission of access control information and is used in point-to-point operation for useful data transmission.

19. The communications network according to claim 14, in that the transmitter and the receiver transmit frameless ATM cells.

20. A method of transmitting a data stream between two nodes of a communications network which are connected via at least two different routes, at least one of the nodes including a radio link running from a transmitter to a receiver, comprising the steps of:
a) recording transmission quality of the radio link;
b) establishing a transmission mode for the radio link by means of the recorded quality; and
c) transmitting the data stream on the radio link on one of the routes if a rate of the data stream does not exceed a transmission rate of an established mode and, if the transmission rate of the established mode exceeds the rate of the data stream, relocating part of the data stream on another of the routes.

21. The method according to claim 20, in that if the data stream consists of a first partial stream with an assured data rate and a second partial stream with a non-assured data rate, the relocated part of the data stream is formed from the second partial stream with the non-assured data rate.

22. The method according to claim 21, in that data from the first partial stream with the assured data rate are relocated only if the transmission rate of the established mode is lower than that of the first partial stream with the assured data rate.

23. The method according to claim 21, in that if the second partial data stream with the non-assured data rate includes a part of time-critical data and a part of non-time-critical data, the relocated part of the data stream is formed from the part of the non-time-critical data.

24. The method according to claim 21, in that the relocated part of the data stream relocated on the other route is discarded if no transmission capacity is available on the other route.

25. The method according to claim 20, in that the transmission quality is measured at the receiver and recorded to the transmitter.

26. The method according to claim 20, in that the radio link is bidirectional, and its quality is measured at the location of the transmitter.
